(19) United States
(12) Patent Application Publication
(10) Pub. No.: US 2012/0317117 A1
(43) Pub. Date: Dec. 13, 2012

(54) Information Visualization System

(75) Inventor: Takayuki AKIYAMA, Kokubunji (JP)

(73) Assignee: Hitachi Solutions, Ltd., Tokyo (JP)

(21) Appl. No.: 13/490,979

(22) Filed: Jun. 7, 2012

(30) Foreign Application Priority Data
Jun. 8, 2011 (JP) 2011-128437

(51) Int. Cl. G06F 17/30

(52) U.S. Cl. 707/737; 707/E17.009

(57) ABSTRACT

Provided is an information visualization system that can present information most suitable for the sensitivity and interest of a user. The information visualization system according to the present invention uses interest degrees of the user for items to calculate relevance between the items and generates an item map reflecting the relevance as coordinate values of the items.

### CLAIM OF PRIORITY

The present application claims priority from Japanese patent application JP 2011-128437 filed on Jun. 8, 2011, the content of which is hereby incorporated by reference into this application.

### BACKGROUND OF THE INVENTION

1. Field of the Invention

The present invention relates to an information visualization system that presents a user with information corresponding to a preference of the user.

2. Background Art

An amount of information provided by various media, such as the Internet, is overwhelming in a modern information civilized society. Therefore, it is difficult for a user to select information useful for the user from an enormous amount of information. Consequently, a search technique is implemented, in which the user inputs a keyword related to desired information to preferentially search only information related to the desired information from an enormous amount of information. A recommendation technique is also started to be implemented, in which a profile of a user (information related to preference and interest) is extracted from an action history such as a history of selection of information items (hereinafter, also “items”) by the user, and information suitable for the profile is presented.

The items herein denote, for example, various pieces of information selected by the user according to interest and preference of the user, such as commodity information, TV program information, book information, and sightseeing spot information.

In the conventional search technique, the user can explicitly input a keyword related to information, which the user is overtly conscious that the information is useful, to thereby obtain items lined up in descending order of relevance to the input keyword. In the conventional recommendation technique, the history of selection of items by the user is used to assume that items related to the item explicitly selected by the user are useful for the user, and the items are recommended in descending order of relevance.

However, not only information overtly recognized by the user, but also covertly recognized information is included in the information useful for the user. The search of the information is difficult in the conventional search systems, unless the information is discovered by chance under special conditions, such as when the information appears by chance in a search result and when all information is browsed.

Therefore, a search system is demanded, in which the user can figure out a perspective of a group of information to access covertly conscious information. An example of the search system includes an information visualization technique (hereinafter, called “item map”) that can plot a group of information on a coordinate space to arrange related information items according to the relevance of the information items to enable to intuitively understand the relevance between the information items.

JP Patent Publication (Kokai) No. 2008-250623A describes a technique of extracting keywords highly related to an input search keyword as related keywords and using the related keywords to create a relevance map. In the literature, principal component analysis is applied to each document with respect to a co-occurrence frequency of the search keyword and the related keywords, and coordinates of the keywords on a predetermined plane are calculated based on resultant first principal component value and second principal component value to generate a relevance map.

JP Patent Publication (Kokai) No. 2010-140275 describes a technique related to a tag cloud, in which conceptually related keywords among keywords (called “tags”) indicating the content of items are closely arranged on a two-dimensional space. In the literature, the user can easily select tags close to an interested tag. The relevance between the tags is stored in advance in a database.

### SUMMARY OF THE INVENTION

The relevance between pieces of information largely depends on the personality of the individual user. For example, which of “udon” and “soba” is more related to “katsudon” would be different depending on the sensitivity of the individual. The sensitivity and interest of the individual user as well as the relevance between pieces of information for the individual user are not reflected in the conventional techniques. Therefore, information optimal for the user is not necessarily displayed at an appropriate location on the item map, and the user may overlook the information optimal for the user.

Even if the large amount of information is all displayed on the item map, it is significantly difficult for the user to browse and evaluate all of the information. Therefore, an information search method is necessary that allows the user to intuitively figure out the item map, i.e., that allows the user to easily understand where and what kind of information exists.

The present invention has been made in view of the problems, and an object of the present invention is to provide an information visualization system that can present information suitable for the sensitivity and interest of an individual user.

An information visualization system according to the present invention uses interest degrees of a user for items to calculate relevance between the items to generate an item map reflecting the relevance as coordinate values of the items.

According to the information visualization system of the present invention, interested items of the user are associated and presented on the item map. Therefore, item arrangement on the item map can be associated with the sensitivity and interest of each individual user.

### BRIEF DESCRIPTION OF THE DRAWINGS

FIG. 1 is a functional block diagram of an information visualization system 100 according to a first embodiment.

FIGS. 2A and 2B are diagrams showing examples of configuration of interest degree information stored in a user interest degree database 101.

FIGS. 3A and 3B are diagrams showing examples of configuration of attribute information of items stored in an item database 102.

FIG. 4 is a diagram showing an example of configuration of an item map display screen displayed by a display unit 104.

FIG. 5 is a flow chart showing an operation of the information visualization system 100.

FIG. 6 is a functional block diagram of the information visualization system 100 according to a second embodiment.

FIGS. 7A and 7B are diagrams showing examples of configuration of coordinate data stored in an item coordinate database 106.

FIGS. 8A and 8B are diagrams showing examples of configuration of cluster structure data stored in a cluster structure database 109.

FIG. 9 is a diagram showing an example of display of an item map according to the second embodiment.

FIG. 10 is a flow chart showing a process when a cluster generation unit 107 uses hierarchical clustering to carry out clustering.

FIG. 11 is a diagram showing a state in which the cluster generation unit 107 uses hierarchical clustering to carry out clustering.

FIG. 12 is a flow chart showing a process when the cluster generation unit 107 carries out clustering according to the number of clusters set in advance.

FIG. 13 is a diagram showing a state in which the cluster generation unit 107 carries out clustering according to the number of clusters set in advance.

FIG. 14 is a functional block diagram of the information visualization system 100 according to a third embodiment.

FIG. 15 is a functional block diagram of the information visualization system 100 according to a fourth embodiment.

FIG. 16 is a diagram showing an example of configuration of data stored in an inter-item relevance database 112.

FIG. 17 is a functional block diagram of the information visualization system 100 according to a fifth embodiment.

FIG. 18 is a diagram showing an example of configuration of action history data stored in a user action history database 114.

FIG. 19 is a configuration diagram of an information presentation system 1000 according to a sixth embodiment.

FIGS. 20A and 20B are diagrams showing an example of configuration of data stored in a user cluster database 202.

FIG. 21 is a diagram showing an operation sequence of the information presentation system 1000.

### DETAILED DESCRIPTION OF THE PREFERRED EMBODIMENTS

### First Embodiment

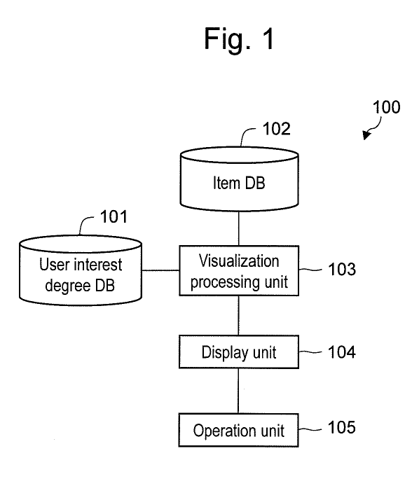

FIG. 1 is a functional block diagram of an information visualization system 100 according to a first embodiment of the present invention. The information visualization system 100 is an apparatus that displays an item map reflecting interest degrees of a user for items. The information visualization system 100 includes a user interest degree database 101, an item database 102, a visualization processing unit 103, a display unit 104, and an operation unit 105.

The user interest degree database 101 stores interest degree information describing the interest degrees of the user for the items. The item database 102 stores attribute information of the items. The visualization processing unit 103 calculates relevance between the items stored in the item database 102 and calculates coordinates of the items on the item map. The display unit 104 displays the item map on a screen based on the coordinates of the items calculated by the visualization processing unit 103. The operation unit 105 receives a user operation on the display screen to reflect the user operation on the screen. The user operation is an operation provided by a general GUI (Graphical User Interface), such as an operation of selecting an item on the screen and an operation of enlarging, reducing, or parallel shifting the screen. The display unit 104 is the “output unit” in the present first embodiment.

The visualization processing unit 103 can include hardware, such as a circuit device that realizes the functions, or can include software defining an arithmetic apparatus, such as a CPU (Central Processing Unit), and operations of the arithmetic apparatus. The data of the user interest degree database 101 and the item database 102 can be stored in a storage device such as a hard disk drive.

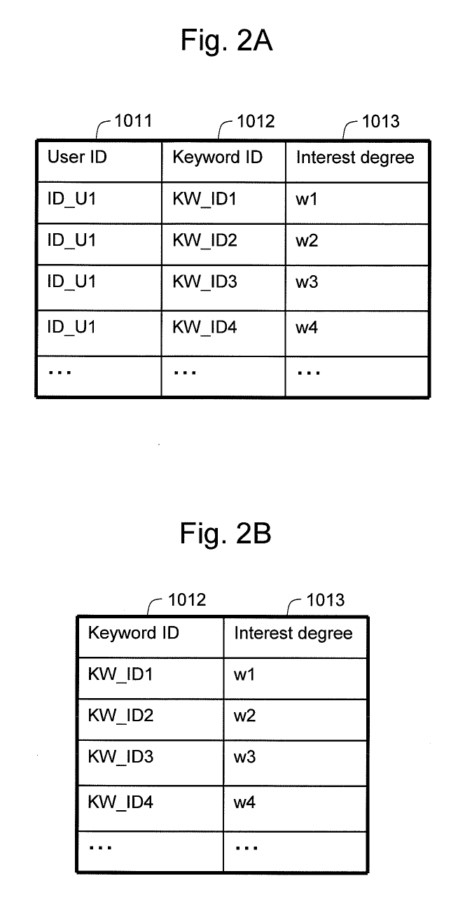

FIGS. 2A and 2B are diagrams showing examples of configuration of the interest degree information stored in the user interest degree database 101. FIG. 2A illustrates an example of configuration for storing interest degrees of a plurality of users. FIG. 2B illustrates an example of configuration for storing interest degrees of a single user.

In the example of configuration shown in FIG. 2A, the user interest degree database 101 includes a user ID field 1011, a keyword ID field 1012, and an interest degree field 1013. The user ID field 1011 holds identifiers for uniquely identifying the users. The keyword ID field 1012 holds identifiers for uniquely identifying keywords indicating content and attributes of the items. The interest degree field 1013 holds values indicating interest degrees of the users for the keywords.

If the user interest degree database 101 is incorporated into personal devices such as portable terminals, individual users do not have to be identified. Therefore, the user ID field 1011 can be omitted as in FIG. 2B.

Values of the interest degree field 1013 can be input when, for example, the user starts using the information visualization system 100. Alternatively, since the interest degrees change over time, the user may periodically input the values. An appropriate input interface can be arranged as necessary if the user inputs the values of the user interest degree database 101.

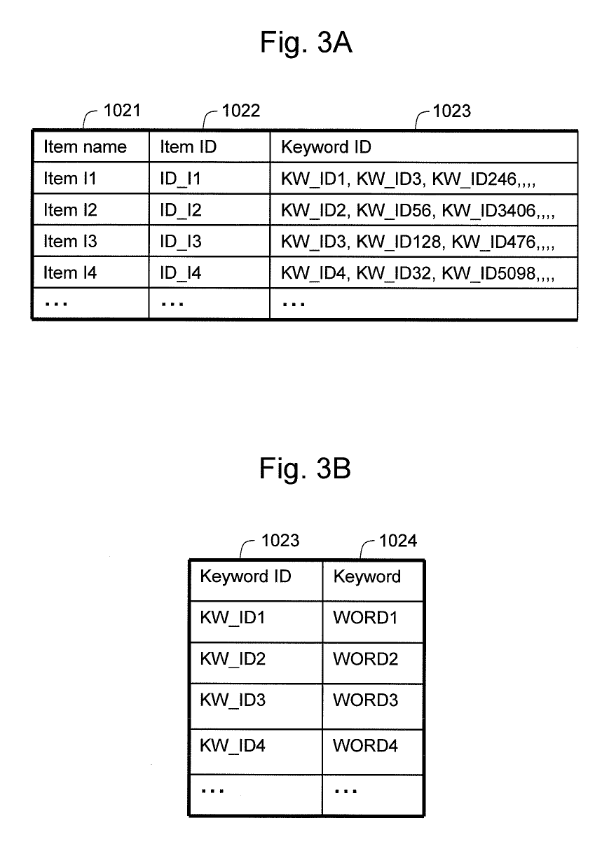

FIGS. 3A and 3B are diagrams showing examples of configuration of attribute information of the items stored in the item database 102. FIG. 3A illustrates a table describing a correspondence between the items and keyword IDs. FIG. 3B illustrates a table describing a corresponding between the keyword IDs and actual keywords.

The item database 102 includes an item name field 1021, an item ID field 1022, a keyword ID field 1023, and a keyword field 1024.

The item name field 1021 holds names of items identified by values of the item ID field 1022. The item ID field 1022 holds identifiers for uniquely identifying the items. The keyword ID field 1023 holds identifiers of keywords describing features of the items identified by the values of the item ID field 1022. The keyword field 1024 holds actual character strings of the keywords identified by the values of the keyword ID field 1023.

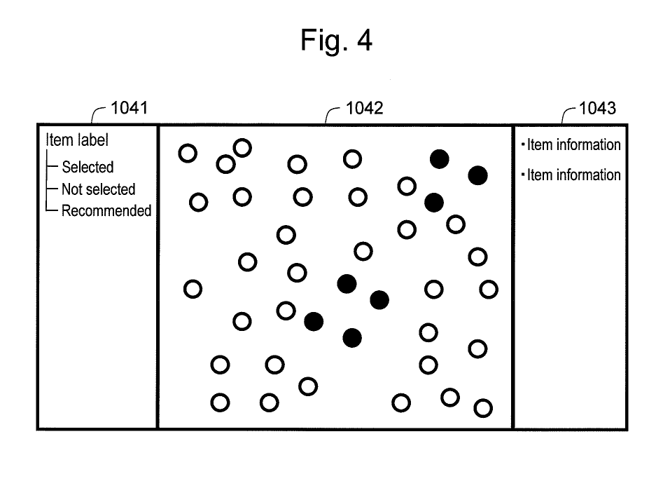

FIG. 4 is a diagram showing an example of configuration of an item map display screen displayed by the display unit 104. The item map display screen includes a label selection panel 1041, an item map panel 1042, and an item information panel 1043.

The label selection panel 1041 displays classification labels of the items. The item map panel 1042 displays an item map. The item information panel 1043 displays attribute information of the items.

The classification labels of the items are character strings for classifying, with an appropriate standard, the items displayed on the screen by the item map panel 1042 and presenting the user with the classification standard. For example, the user selects a “selected” label to highlight only items selected by the user on the item map panel 1042. Alternatively, the user selects a “recommended” label to highlight items recommended for the user by the information visualization system 100 or by an external recommendation system. When the user selects a classification label, only items classified by the classification label are highlighted on the item map panel 1042. The highlighted items are illustrated by black circles, and the other items are illustrated by white circles.

The attribute information of the items is information such as character strings describing the content and features of the items. For example, the attribute information is information of commodity prices and book authors. An appropriate field may be arranged in the item database 102 to store the attribute information, or the attribute information may be acquired from an external database. Keywords may replace the attribute information. When the user selects an item on the item map panel 1042, the attribute information of the item is displayed on the item information panel 1043. If the user selects a plurality of items, the attribute information of the items is displayed.

The visualization processing unit 103 calculates the coordinate values of the items on the item map to arrange highly related items closely. As a result, the related items are arranged closely on the item map panel 1042. Therefore, the user can discover items that have not been discovered near the interested items. The user can also view a perspective of the items to discover unknown interested areas.

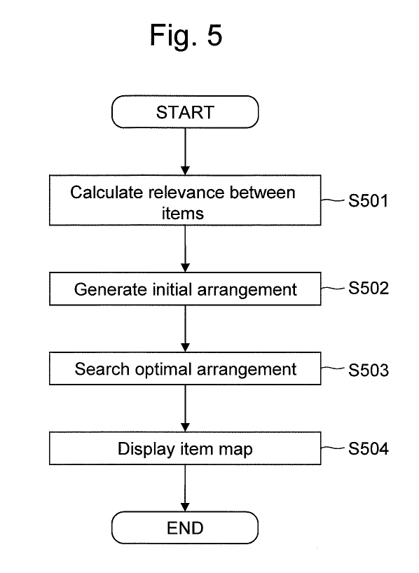

FIG. 5 is a flow chart showing an operation of the information visualization system 100. The steps of FIG. 5 will be described.

### (FIG. 5: Step S501)

The visualization processing unit 103 uses the interest degree information stored in the user interest degree database 101 to calculate relevance between the items stored in the item database 102. The relevance between the items is an index indicating how much the items are related for the individual user, and for example, the following Expression 1 can be used to calculate the relevance.

$$D ( {I}_{i} , {I}_{j} ) = {\sum }_{n}^{N} {w}_{n} \times \vert {I}_{i} ( n ) - {I}_{j} ( n ) \vert \qquad ( Expression 1 )$$

Iᵢ denotes an item with a value i in the item ID field 1022. D(Iᵢ,Iⱼ) denotes relevance between items Iᵢ and Iⱼ, and n denotes a value of the keyword ID field 1023. N denotes a total number of keywords, and wᵢ denotes an interest degree of the user for a keyword with a value i in the keyword ID field 1023 and is equivalent to a value of the interest degree field 1013. Iᵢ(n) indicates whether the item Iᵢ includes a keyword with a value n in the keyword ID field 1023. For example, 1 can be set if the keyword is included, and 0 can be set if the keyword is not included.

### (FIG. 5: Steps S502 and S503: Outline)

The visualization processing unit 103 calculates the coordinate values of the items to arrange the items on the item map by reflecting the inter-item relevance calculated in step S501. The coordinate values can be calculated using a generally known method such as multidimensional scaling, self-organizing map, and principal component analysis. An example of using the multidimensional scaling will be described in the present first embodiment. When the multidimensional scaling is used, the visualization processing unit 103 calculates the coordinate values of the items to reduce the difference between an inter-item distance on the item map and the inter-item relevance calculated in S501 as much as possible.

### (FIG. 5: Step S502)

The visualization processing unit 103 randomly generates an initial arrangement of the items on the item map.

### (FIG. 5: Step S503)

The visualization processing unit 103 calculates the difference between the inter-item distance and the inter-item relevance to search an optimal arrangement that minimizes the difference. For example, the visualization processing unit 103 adjusts the coordinates of the items on the item map to minimize values of functions for calculating the difference between the inter-item distance and the inter-item relevance. Examples of specific methods include a steepest descent method, an Euler's method, a Euclid's method, and a genetic algorithm.

### (FIG. 5: Step S503: Supplement 1)

The difference between the inter-item distance and the inter-item relevance can be calculated using, for example, the following Expression 2.

$$E = {\sum }_{i , j}^{Nall} \vert D ( {I}_{i} , {I}_{j} ) - {D}_{vis} ( {I}_{i} , {I}_{j} ) \vert \qquad ( Expression 2 )$$

E is a function indicating the difference between the inter-item distance and the inter-item relevance. Nall denotes a total number of items. D(Iᵢ,Iⱼ) denotes the inter-item relevance calculated using Expression 1. Dᵥᵢₛ(Iᵢ,Iⱼ) denotes the inter-item distance on the item map.

### (FIG. 5: Step S503: Supplement 2)

The following Expression 3 can be used to calculate Dᵥᵢₛ(Iᵢ,Iⱼ).

Dᵥᵢₛ(Iᵢ,Iⱼ){square root over ((Iᵢ(x)−Iⱼ(x))²+Iᵢ(y)−Iⱼ(y))²)} (Expression 3)

The characters x and y denote coordinate values on the item map. Iⱼ(x) denotes an x coordinate of the item Iᵢ. Iᵢ(y) denotes a y coordinate of the item Iᵢ.

### (FIG. 5: Step S503: Supplement 3)

Although an example of forming the item map as a two-dimensional plane has been illustrated, an item map in a three or more dimensional space may also be created. A formula other than Expression 1 may be used to calculate E, as long as the formula indicates the difference between the inter-item distance and the inter-item relevance.

### (FIG. 5: Step S504)

The visualization processing unit 103 uses the coordinate values of the items on the item map calculated in step S503 to create an item map. The display unit 104 displays the item map on the item map display screen.

### (FIG. 5: Steps S501 to S504: Supplement)

The process may be carried out upon designation by the user or may be periodically carried out at predetermined time intervals. The process may also be carried out on the background when the user is not operating the information visualization system 100.

### First Embodiment: Summary

In this way, the information visualization system 100 according to the present first embodiment reflects the interest degrees of the user for the items on the item arrangement on the item map. As a result, an item map corresponding to the preference and interest specific to the user can be created.

For example, if the items are books, the attribute information of the items includes authors, publishers, and genre information such as “mystery” and “romance”. The user interest degree database 101 holds the interest degrees of the user for the items. For example, the user may place a greater emphasis on information related to the authors than information related to the genre in the selection of a book. On the other hand, the user may put a greater emphasis on the genre than the authors to select a book. The information visualization system 100 can display an item map suitable for the interest degrees of individual users on the screen. In this way, unread books can be figured out in a field that the user is interested in. A totally unknown book field for the user can be discovered to prompt the user to read a book in a new field.

For example, if the items are TV programs, the attribute information of the items includes a broadcast station, cast, and genre information such as “variety” and “drama”. The user interest degree database 101 holds the interest degrees of the user for the items. For example, the user may place a greater emphasis on information related to the cast than information related to the genre when watching a TV program. On the other hand, the user may put a greater emphasis on the genre than the cast to watch a TV program. According to the present first embodiment, TV programs that are not viewed yet can be figured out in a field that the user is interested in. A field of TV program that the user does not know at all can be discovered to prompt the user to watch a TV program in a new field.

Therefore, according to the information visualization system 100 of the present first embodiment, the user can obtain item information suitable for the sensitivity and preference of the user from a wide variety of fields. As a result, the living activities are enriched, and services that do not bore the user can be used. Since the user can discover new information areas, intellectual production activities such as commodity projects can be promoted.

The function of displaying the item map on the screen can be arranged outside of the information visualization system 100 in the first and following embodiments. In that case, the visualization processing unit 103 outputs only data such as the coordinate information of the items on the item map.

### Second Embodiment

An example of configuration of generating clusters on the item map to promote understanding of the item map will be described in a second embodiment of the present invention. The configuration of the information visualization system 100 is the same as in the first embodiment except for a configuration related to the clusters, and the configuration of the clusters will be mainly described.

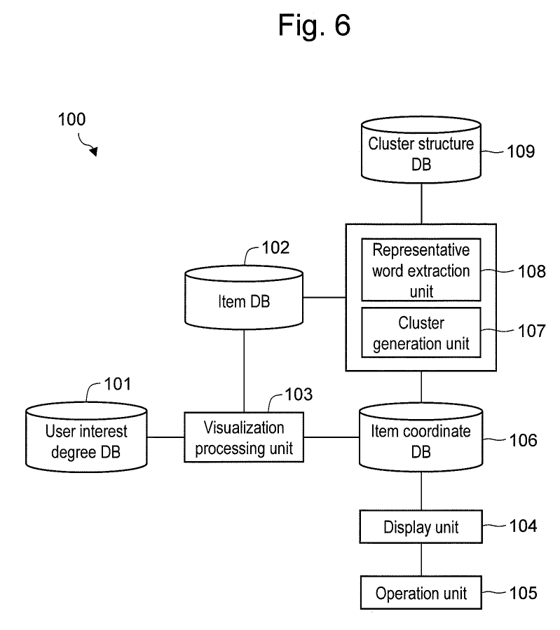

FIG. 6 is a functional block diagram of the information visualization system 100 according to the present second embodiment. In the present second embodiment, the information visualization system 100 clusters a plurality of items on the item map and displays, along with the clusters, terms (representative words) that most excellently indicate features of the items included in the clusters. Along with a change in the screen scale after enlargement or reduction of the item map, the information visualization system 100 dynamically changes the items that form the clusters and the representative words. The information visualization system 100 according to the present second embodiment has a configuration necessary to carry out the processes.

In addition to the configuration described in the first embodiment, the information visualization system 100 includes an item coordinate database 106, a cluster generation unit 107, a representative word extraction unit 108, and a cluster structure database 109 in the present second embodiment.

The item coordinate database 106 stores coordinate values of the items on the item map calculated by the visualization processing unit 103. The process of generating the clusters is necessary in the present second embodiment. Therefore, the coordinate values of the items can be calculated in advance and held in the item coordinate database 106 from the viewpoint of reducing the processing load.

The cluster generation unit 107 uses the coordinate values of the items stored in the item coordinate database 106 to cluster the items. The representative word extraction unit 108 extracts representative words that most excellently indicate features of the items included in the clusters generated by the cluster generation unit 107, from the keywords stored in the item database 102. The cluster structure database 109 stores the cluster structure generated by the cluster generation unit 107.

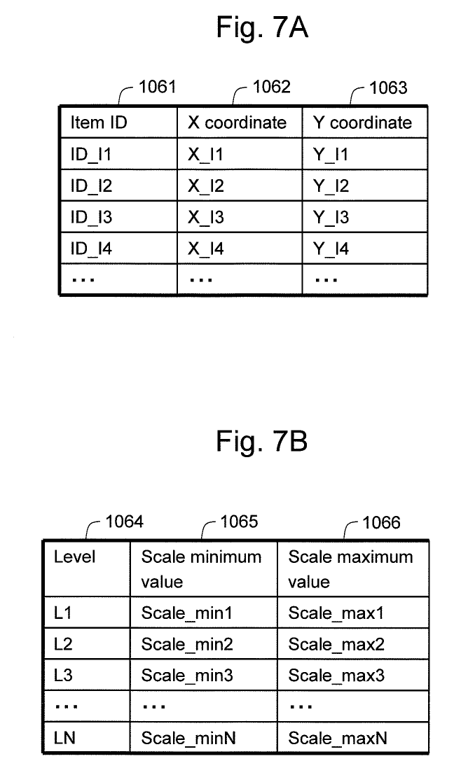

FIGS. 7A and 7B are diagrams showing examples of configuration of coordinate data stored in the item coordinate database 106. FIG. 7A is a diagram showing an example of configuration of a table storing the coordinate values of the items on the item map. FIG. 7B is a diagram showing an example of configuration of a table describing a standard of dividing the display scale of the item map. The display scale denotes scaling in a general map, and for example, the display scale can be calculated based on a ratio between an item map area currently displayed on the screen and a minimum item map area including all items.

The table shown in FIG. 7A includes an item ID field 1061, an X coordinate field 1062, and a Y coordinate field 1063. The table holds X and Y coordinate values on the item map of the items identified by values of the item ID field 1061. The visualization processing unit 103 calculates the coordinate values of the items and stores the coordinate values in the table.

The table shown in FIG. 7B includes a level field 1064, a scale minimum value field 1065, and a scale maximum value field 1066. The display scale of the item map can be classified by scale values. An example of classification into N stages is illustrated here. According to the example of data shown in FIG. 7B, the display scale is in a level L1 when the scale of the item map is within a range of Scale_min1 to Scale_max1.

The reason that the display scale is classified is that the items included in the clusters change depending on the scaling of the item map. For example, the number of items included in a single cluster is large when the item map includes a wide range of items. The number of items included in a signal cluster is small when the item map displays only a narrow range of items on the screen. The table of FIG. 7B is meaningful in preparing to classify the display scale of the item map to create the clusters suitable for the display scale for each level. The cluster generation unit 107 also calculates a correspondence between the levels and the display scales when generating the clusters and stores the correspondence in the table of FIG. 7B.

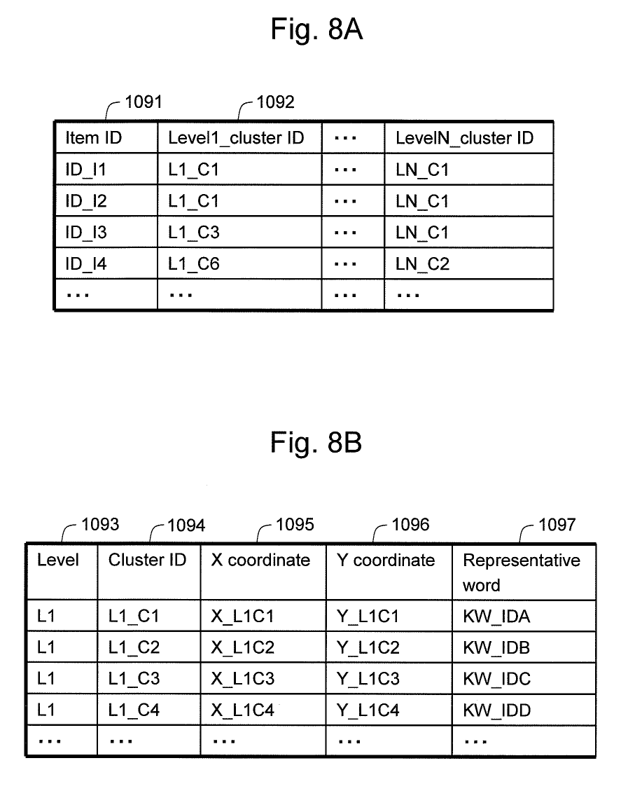

FIGS. 8A and 8B are diagrams showing examples of configuration of cluster structure data stored in the cluster structure database 109. FIG. 8A is a diagram showing an example of configuration of a table defining the clusters including the items, for each display scale (level) of the item map. FIG. 8B is a diagram showing an example of configuration of a table defining central coordinate values and representative words of the clusters, for each display scale (level) of the item map.

The table shown in FIG. 8A includes an item ID field 1091 and a cluster ID field 1092. If a different cluster is formed for each display scale (level), a plurality cluster ID fields 1092 may be arranged. The table defines to which of the clusters described in the table of FIG. 8B the items identified by the values of the item ID field 1091 belong.

The table shown in FIG. 8B includes a level field 1093, a cluster ID field 1094, an X coordinate field 1095, a Y coordinate field 1096, and a representative word field 1097.

The level field 1093 holds values showing the display scales (levels) of the item map. The field corresponds to the level field 1064. The cluster ID field 1094 holds identifiers of the clusters displayed on the screen when the display scale of the item map has the values shown in the level field 1093. The field corresponds to the cluster ID field 1092. The X coordinate field 1095 and the Y coordinate field 1096 hold central coordinates of the clusters identified by the values of the cluster ID field 1094. The representative word field 1097 holds representative words of the clusters identified by the values of the cluster ID field 1094. The representative word extraction unit 108 may extract the representative words, or the user may input the representative words.

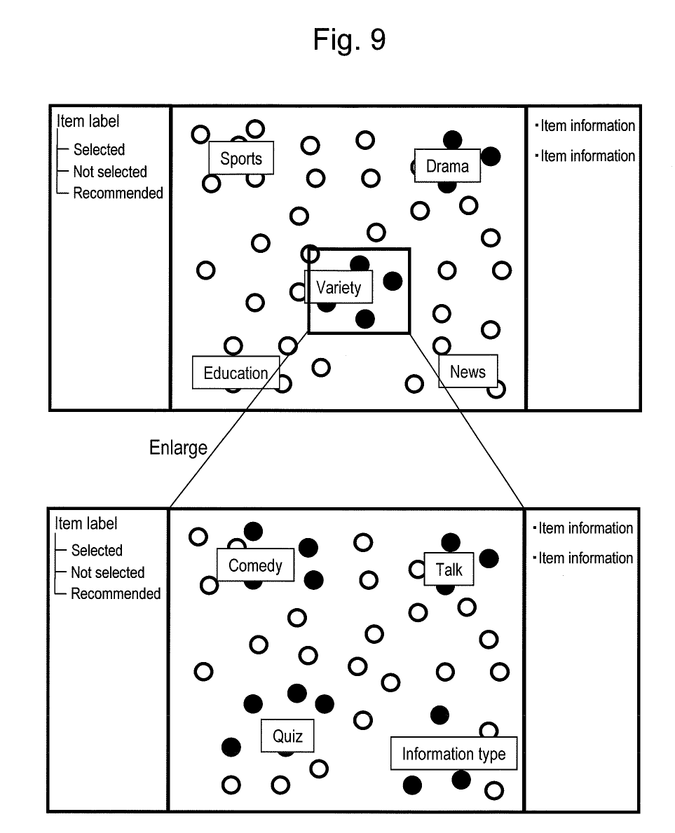

FIG. 9 is a diagram showing an example of display of the item map according to the present second embodiment. If the items are TV programs, the representative word extraction unit 108 extracts representative words of the clusters, such as “sports”, “drama”, “variety”, “education”, and “news”.

The items included in the item map increase or decrease when the display scale of the item map is enlarged or reduced. Therefore, the cluster configuration also changes. FIG. 9 illustrates an example, in which a cluster with a representative word “variety” is enlarged and displayed to subdivide the cluster configuration. The cluster configuration to be displayed on the screen in each display scale can be obtained from the cluster structure database 109. The same applies to the items belonging to the clusters of each level. The correspondence between the display scale and the level can be obtained from the item coordinate database 106.

The user may be able to edit the representative words of the clusters. For example, a function of selecting a representative word on the item map panel 1042 to edit a new representative word can be arranged. The new representative word may be stored in the item database 102 or may be stored in other appropriate data.

The configuration of the information visualization system 100 according to the present second embodiment has been described. Processes of the cluster generation unit 107 and the representative word extraction unit 108 will be described.

The cluster generation unit 107 clusters the items based on the coordinate values on the item map. The representative word extraction unit 108 extracts representative words most excellently indicating the content of the generated cluster from the item database 102. Instead of clustering the items based on the keywords, the items are clustered based on the coordinate values on the item map. In this way, the calculation cost can be significantly reduced.

The cluster generation unit 107 uses the coordinate values on the item map to calculate the distances between the items and allocates items in close distance to the same cluster. The inter-item distance may be calculated using Expression 3, or other formulas may be used. Conventional methods, such as hierarchical clustering and a method of setting the number of clusters in advance (for example, k-means), may be used as the clustering method, and a format of permitting an overlap in the cluster may be adopted. A processing procedure of the cluster generation unit 107 will be described as an example of the two methods.

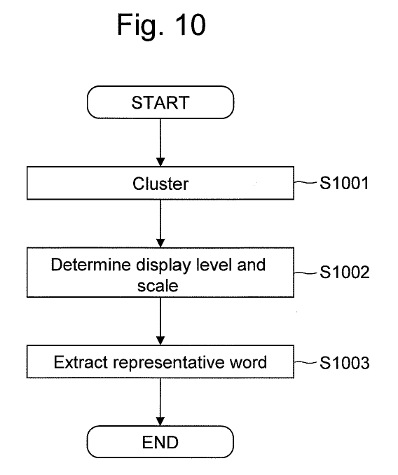

FIG. 10 is a flow chart showing a process when the cluster generation unit 107 uses the hierarchical clustering to carry out clustering. The steps of FIG. 10 will be described.

### (FIG. 10: Step S1001)

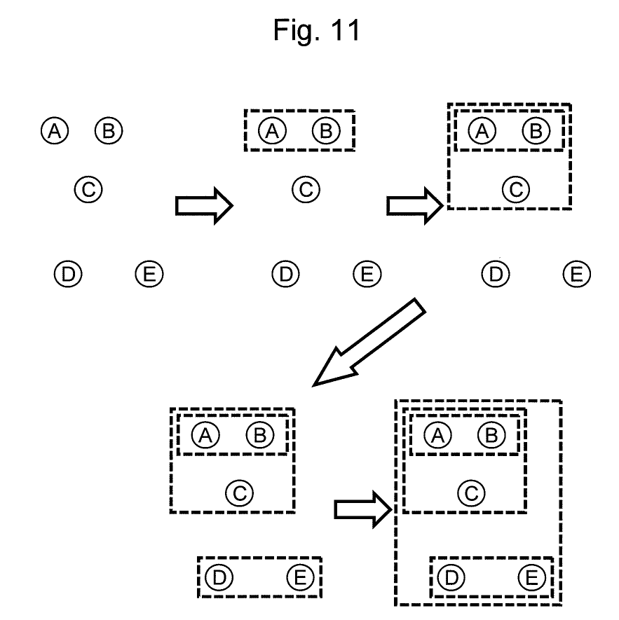

The cluster generation unit 107 repeats a procedure described later in FIG. 11 to cluster the items held in the item database 102.

### (FIG. 10: Step S1002)

The cluster generation unit 107 calculates the sizes of the clusters generated in step S1001 based on the numbers of items belonging to the clusters or based on areas of rectangles or circles including the items. The cluster generation unit 107 determines display levels according to the number of clusters included in the screen and determines the clusters to be displayed on the screen in each display level. The user may set the number of display levels in advance. Only the maximum number of clusters to be displayed on the screen in each display level may be set, and the clusters to be displayed on the screen in each display level may be determined within the range. The cluster generation unit 107 stores a result of steps S1001 to S1002 in the cluster structure database 109.

### (FIG. 10: Step S1003)

The representative word extraction unit 108 extracts representative keywords indicating the content of the clusters generated by the cluster generation unit 107 in step S1001. For example, the representative word extraction unit 108 can extract, as the representative words, keywords that distinctively appear among the keywords included in the content of the items belonging to the cluster. Specifically, a generally known distinctive word extraction method, such as TF-IDF (Term Frequency-Inverse Document Frequency) and SMART, can be used.

FIG. 11 is a diagram showing a state in which the cluster generation unit 107 uses the hierarchical clustering to carry out clustering. In the hierarchical clustering, a process of placing items within close distance in the same clusters is sequentially repeated, and the clustering is finished when all items belong to the same clusters.

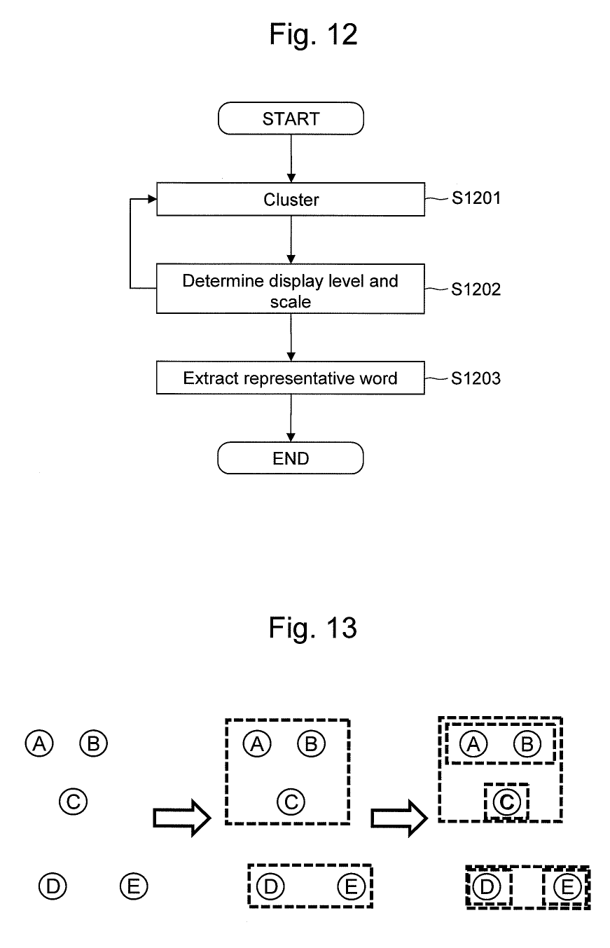

FIG. 12 is a flow chart showing a process when the cluster generation unit 107 carries out clustering according to the number of clusters set in advance. The steps of FIG. 12 will be described.

### (FIG. 12: Step S1201)

The cluster generation unit 107 carries out a procedure described later in FIG. 13 to cluster the items held in the item database 102.

### (FIG. 12: Step S1202)

The cluster generation unit 107 calculates sizes of the clusters generated in step S1201 based on the numbers of items belonging to the clusters or based on areas of rectangles or circles including the items. The cluster generation unit 107 determines whether to further carry out clustering within the cluster. The cluster generation unit 107 stores a result of steps S1201 and S1202 in the cluster structure database 109.

### (FIG. 12: Step S1203)

The present step is the same as step S1003 of FIG. 10.

FIG. 13 is a diagram showing a state in which the cluster generation unit 107 carries out clustering according to the number of clusters set in advance. The cluster generation unit 107 groups the items to divide the items into a preset number of clusters. The same process is also carried out within the generated clusters.

### Second Embodiment: Summary

In this way, the information visualization system 100 according to the present second embodiment clusters the items on the item map and displays the items along with the representative words of the clusters. As a result, the user can easily understand the relationship between the items.

The information visualization system 100 according to the present second embodiment separately generates clusters for each display scale of the item map and stores the clusters in the cluster structure database 109. Therefore, an easily viewable item map can be provided by preventing a situation in which when the display scale is changed, the cluster structure before the change remains on the screen to degrade the visibility. The clusters do not have to be generated every time the display scale of the item map is changed, and the processing load can be reduced.

The information visualization system 100 according to the present second embodiment stores the coordinate values of the items on the item map in the item coordinate database 106. Therefore, the process of the visualization processing unit 103 does not have to be carried out every time the cluster is created, and the processing load can be reduced.

### Third Embodiment

A third embodiment of the present invention describes an example of configuration in which when a new item is registered in the item database 102 with the configuration described in the second embodiment, only the cluster including the item is updated to speed up the calculation of the visualization processing unit 103.

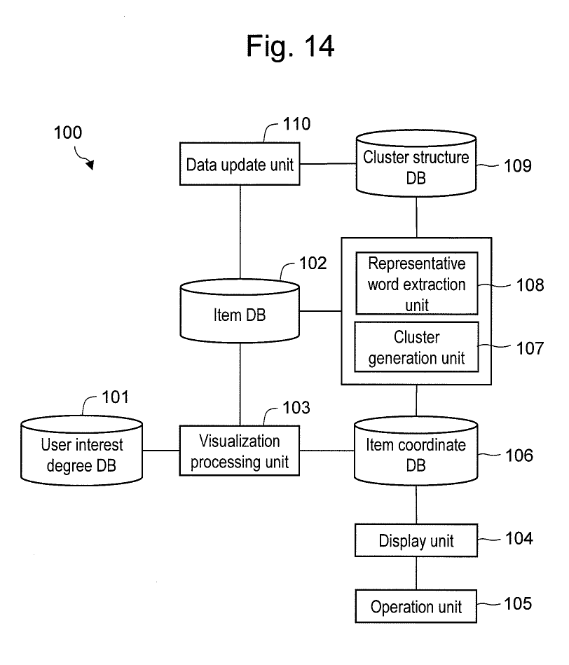

FIG. 14 is a functional block diagram of the information visualization system 100 according to the present third embodiment. In addition to the configuration described in the second embodiment, the information visualization system 100 according to the present third embodiment includes a data update unit 110.

The data update unit 110 stores new item data in the item database 102. The data update unit 110 calculates the relevance between the items stored before and the newly added item and temporarily sets the coordinate values of the items with the highest relevance to the newly added item (or one of the items with more than a predetermined value of relevance) as coordinate values of the newly added item.

The visualization processing unit 103 handles the coordinate values temporarily set by the data update unit 110 as initial values to calculate the item arrangement that minimizes the difference between the inter-item distance and the inter-item relevance for the newly added item and updates the temporarily set coordinate values.

Based on the same method as in the second embodiment, the cluster generation unit 107 determines in which cluster the newly added item will be placed and stores the result in the cluster structure database 109.

As a result of the process, the visualization processing unit 103 and the cluster generation unit 107 do not have to rearrange the coordinate values or reconfigure the clusters for all items. The processing load can be reduced, and the response for the user can be speeded up.

The user may set in advance the frequency of the update process by the data update unit 110, or the update may be carried out when the number of newly added items is over a predetermined threshold.

### Fourth Embodiment

A fourth embodiment of the present invention describes an example of configuration in which the relevance between the items is calculated in advance to speed up the process by the visualization processing unit 103. The configuration of the information visualization system 100 is mostly the same as in the first to third embodiments, and differences will be mainly described.

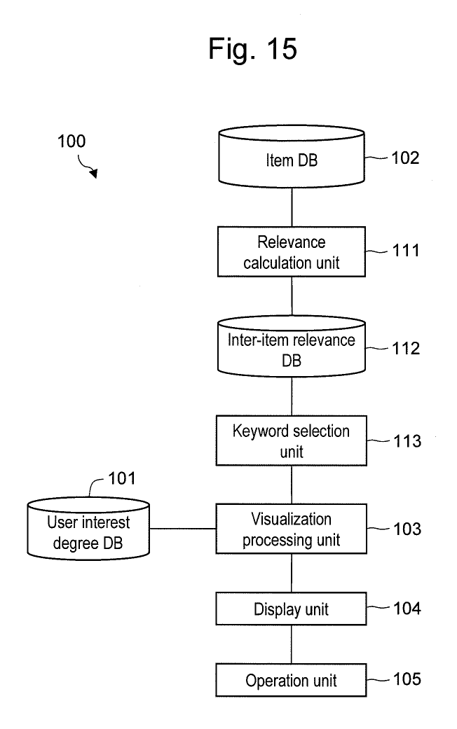

FIG. 15 is a functional block diagram of the information visualization system 100 according to the present fourth embodiment. In addition to the configuration described in the first to third embodiments, the information visualization system 100 according to the present fourth embodiment includes a relevance calculation unit 111, an inter-item relevance database 112, and a keyword selection unit 113. Although an example of adding the function units to the configuration described in the first embodiment is illustrated here, the function units can be added to the configurations described in the other embodiments.

The relevance calculation unit 111 extracts keywords different from each other among the keywords included in the items stored in the item database 102. The inter-item relevance database 112 stores the keywords that are extracted by the relevance calculation unit 111 and that are different from each other between the items. The keyword selection unit 113 selects keywords to be used by the visualization processing unit 103 from the user interest degree database 101 based on the data stored in the inter-item relevance database 112.

The difference from the first to third embodiments is that the visualization processing unit 103 uses only the keywords selected by the keyword selection unit 113 to calculate the relevance between the items, instead of using all keywords stored in the user interest degree database 101 to calculate the relevance between the items.

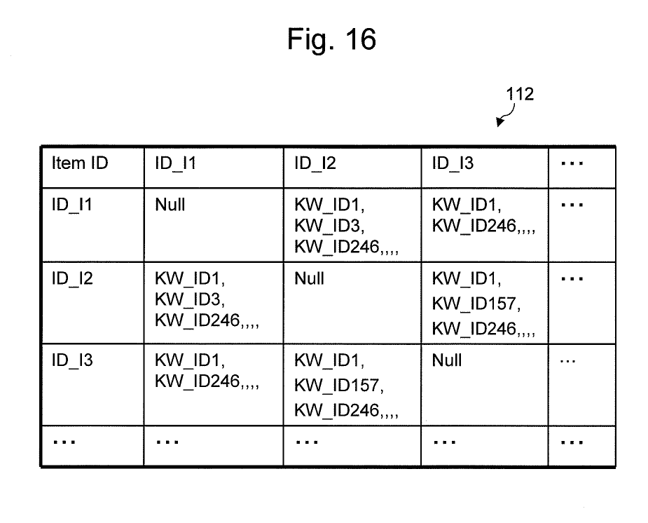

FIG. 16 is a diagram showing an example of configuration of the data stored in the inter-item relevance database 112. The inter-item relevance database 112 holds a list of keywords that do not match among the keywords included in the items. Based on the assumption that Expression 1 described above is used to calculate the relevance between the items, the keywords included in one item but not included in the other items are extracted in advance to reduce the calculation load of Expression 1.

Among the keywords stored in the item database 102, the keyword selection unit 113 extracts only keywords that match the keywords stored in the inter-item relevance database 112 and transmits the keywords to the visualization processing unit 103. The visualization processing unit 103 uses only the keywords to calculate the item arrangement on the item map. Expression 1 is adapted to calculate the relevance between the items by multiplying the number of keywords included in one item but not included in the other items by the interest degree wᵢ of each keyword as a weighting factor and then integrating the results. In place of this, the inter-item relevance can be calculated based on the number of keywords that do not match between the items in the present fourth embodiment. Therefore, the relevance between the items can be obtained without using the interest degree wᵢ. More specifically, the relevance calculation unit 111 can calculate or extract parameters synonymous with the inter-item relevance in advance and store the parameters in the inter-item relevance database 112 to reduce the calculation load of the visualization processing unit 103.

The configuration is designed to reduce the calculation load when the visualization processing unit 103 uses Expression 1 to calculate the relevance between the items. Therefore, other configurations can also be used if the same effect can be attained. For example, the relevance calculation unit 111 can use Expression 1 to calculate the relevance between the items and store the result in advance in the inter-item relevance database 112. The visualization processing unit 103 can read the inter-item relevance from the inter-item relevance database 112 to use the inter-item relevance to optimize the item arrangement.

### Fourth Embodiment: Summary

As described, the information visualization system 100 according to the present fourth embodiment calculates the relevance between the items in advance and stores the relevance between the items in the inter-item relevance database 112. The information visualization system 100 uses the relevance between the items to arrange the items on the item map. This can reduce the calculation load of the visualization processing unit 103.

### Fifth Embodiment

A fifth embodiment of the present invention describes an example of configuration for learning interest degrees of the user for the items from a past action history of the user to reflect a temporal change in the interest degrees to create an item map.

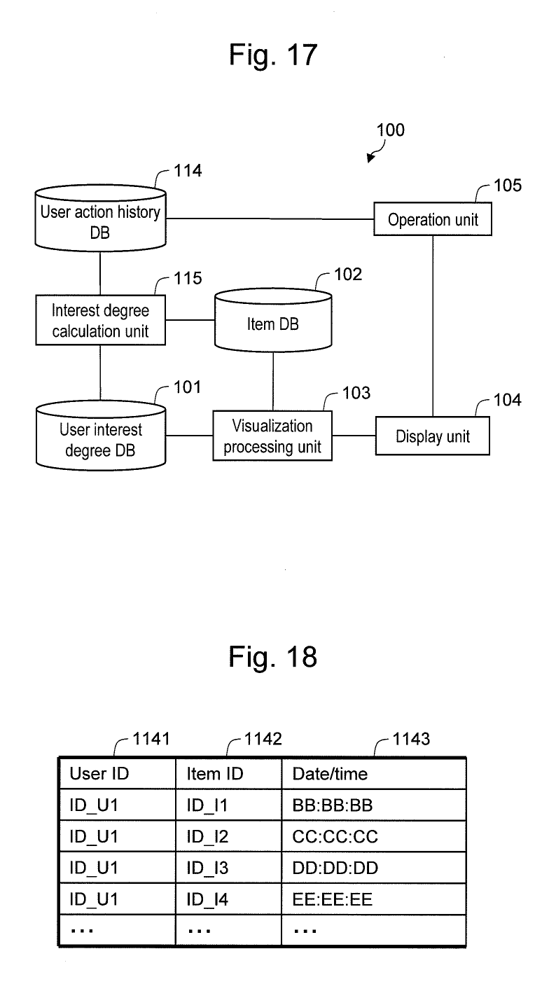

FIG. 17 is a functional block diagram of the information visualization system 100 according to the present fifth embodiment. In addition to the configuration described in the first to fourth embodiments, the information visualization system 100 according to the present fifth embodiment includes a user action history database 114 and an interest degree calculation unit 115. Although an example of adding the function units to the configuration described in the first embodiment has been illustrated here, the function units can also be added to the configurations described in the other embodiments.

The user action history database 114 stores an action history of results of selection of items in the past by the user. The interest degree calculation unit 115 uses the action history of the user stored in the user action history database 114 to learn and calculate the interest degrees of the user for the items. The user interest degree database 101 stores interest degree information calculated by the interest degree calculation unit 115.

FIG. 18 is a diagram showing an example of configuration of action history data stored in the user action history database 114. The user action history database 114 includes a user ID field 1141, an item ID field 1142, and a date/time field 1143.

The user ID field 1141 holds identifiers for uniquely identifying the users. The item ID field 1142 holds identifiers for uniquely identifying the items. The date/time field 1143 holds date and time of some kind of actions that are carried out by the users identified by the values of the user ID field 1141 and that are carried out for the items (for example, selection of items) identified by the values of the item ID field.

The action history stored in the user action history database 114 may be input from the outside of the information visualization system 100, or an operation history acquired from the operation unit 105 may be stored as the action history in the user action history database 114.

When the action history is input from the outside of the information visualization system 100, for example, a positioning apparatus, such as a GPS (Global Positioning System), can be used to track the moving trajectory of the user to acquire the action history. Specifically, the information visualization system 100 can function as a portable terminal, and a terminal location when the user selects an item on the terminal can be stored as an action history along with the date/time field 1143. Alternatively, the user may manually input the action history of the user.

The actions here denote actions related to the interest of the user, such as eating a meal and watching a video. In this case, the items held by the item database 102 include a food menu, a watched TV program, video content such as a DVD, etc. The keywords in this case can be arbitrary keywords that describe the items, such as words describing the items and registration date of the items in the database. The keywords distributed by a metadata creation company may be used, or the keywords may be automatically generated from information on the Internet, etc.

Examples of other actions include a sightseeing action, search of a document such as a research paper and a patent document, search of information using the Internet, and handling of a failure. In this case, the items held by the item database 102 can be a sightseeing spot, a document title, a URL, a failure handling manual, etc.

The interest degree calculation unit 115 learns and calculates the interest degrees of the user for the keywords stored in the user interest degree database 101. For example, the frequency of appearance of the keywords associated with the item ID field 1142 included in each history held in the user action history database 114 can be used to calculate the interest degrees. The date/time field 1143 may be used to target only the action history close to the current date and time.

When the operation history obtained from the operation unit 105 is used to update the user action history database 114, the operations of selecting the items by the user can be stored as the action history.

The user may set in advance the frequency of updating the user action history database 114, or the user may update the user action history database 114 according to the frequency of the user using the information visualization system 100. The update function may be arranged as part of the functions of the user action history database 114, or a function unit that carries out the update can be separately arranged.

### Fifth Embodiment: Summary

In this way, the information visualization system 100 according to the present fifth embodiment updates the interest degrees of the user for the items according to the action history of the user. As a result, the temporal change in the interest degrees can be automatically reflected on the item map.

### Sixth Embodiment

The interest degrees of the user for the items are unknown for the information visualization system 100 for the user who has newly started using the information visualization system 100. Therefore, the item map cannot be effectively created. A sixth embodiment of the present invention describes an example of configuration of using, for a new user, the user interest degree database 101 of a user with interested matters similar to those of the new user among the existing users.

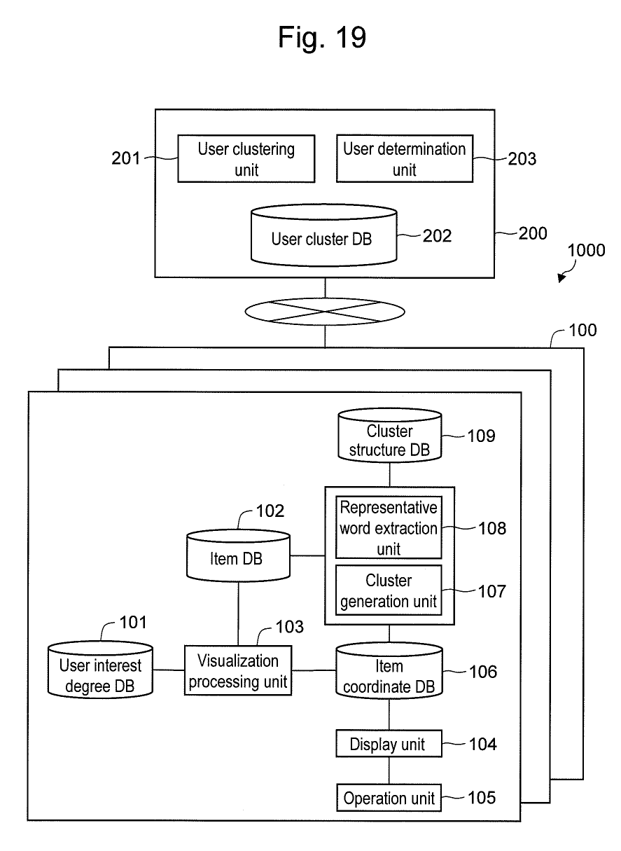

FIG. 19 is a configuration diagram of an information presentation system 1000 according to the present sixth embodiment. The information presentation system 1000 includes a plurality of information visualization systems 100 and a center server 200. The configuration of the information visualization system 100 is similar to the configurations described in the first to fifth embodiments. The configuration described in the second embodiment is illustrated here.

The center server 200 is an apparatus that assembles the interest degree information of the users held in the user interest degree databases 101 of the information visualization systems 100 to cluster the users according to the interest degree information. The center server 200 includes a user clustering unit 201, a user cluster database 202, and a user determination unit 203.

The user clustering unit 201 clusters the users according to the interest degrees for the items. The user cluster database 202 stores results of clustering by the user clustering unit 201. The user determination unit 203 determines to which of the user clusters stored in the user cluster database 202 the new user belongs, according to the interest degrees of the new user.

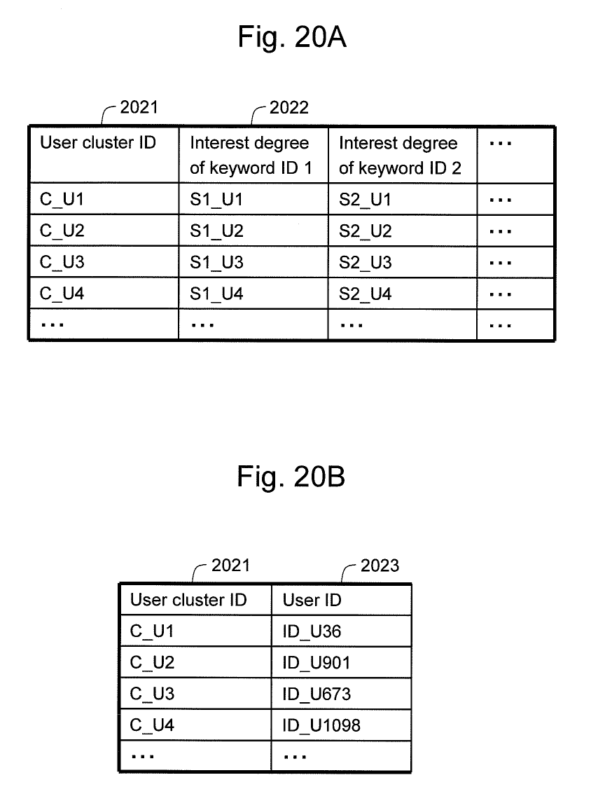

FIGS. 20A and 20B are diagrams showing examples of configuration of the data stored in the user cluster database 202. FIG. 20A is a table storing representative values of the interest degrees of the users belonging to the user clusters. FIG. 20B is a table holding user IDs of representative users belonging to the user clusters.

The table shown in FIG. 20A includes a user cluster ID field 2021 and a keyword interest degree field 2022. The user cluster ID field 2021 holds identifiers of the user clusters created by clustering of the users by the user clustering unit 201. The keyword interest degree field 2022 holds representative values of the interest degrees of the users, who belong to the clusters, for the keywords related to the items. A statistical index value, such as an average and a mode, of the interest degrees of the user belonging to the cluster may be used as the representative value of the interest degrees, or the user may set the representative value.

The table shown in FIG. 20B includes a user cluster ID field 2021 and a user ID field 2023. The user ID field 2023 holds user IDs of the representative users of the user clusters identified by the values of the user cluster ID field 2021.

The configuration of the information presentation system 1000 according to the present sixth embodiment has been described. A detailed operation of the information presentation system 1000 will be described.

The user clustering unit 201 uses the interest degree information stored in the user interest degree databases 101 of the information visualization systems 100 to calculate dissimilarity between the users. For example, the following expression 4 can be used to calculate the dissimilarity between the users.

$$D ( {U}_{i} , {U}_{j} ) = {\sum }_{n}^{N} \vert {U}_{i} ( n ) - {U}_{j} ( n ) \vert \qquad ( Expression 4 )$$

Uᵢ denotes a user with a user ID i. D(Uᵢ,Uⱼ) denotes dissimilarity between users Uᵢ and Uⱼ, and n denotes a keyword ID. N denotes a total number of keywords, and Uᵢ(n) denotes an interest degree of a user with the user ID i for a keyword with a keyword ID n. These are stored in the interest degree database of each user.

The user clustering unit 201 can use the same method as described in the first embodiment to cluster the users. The user may set in advance the number of clusters stored in the user cluster database 202, or an optimal number of clusters may be determined according to the number of users belonging to the clusters. Among the users belonging to a user cluster, the user that represents the cluster is a user with the interest degree closest to the representative value of the interest degrees of the users belonging to the cluster.

The user determination unit 203 uses the interest degrees stored in the user cluster database 202 to calculate the dissimilarity between the clusters and the new user and places the new user in a cluster with the smallest dissimilarity.

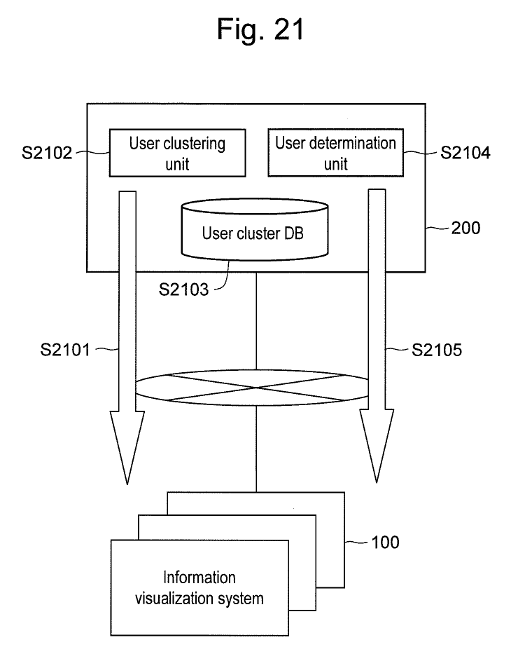

FIG. 21 is a diagram showing an operation sequence of the information presentation system 1000. The steps of FIG. 21 will be described.

### (FIG. 21: Step S2101)

The user clustering unit 201 of the center server 200 acquires the interest degree information of the users from the user interest degree databases 101 included in the information visualization systems 100.

### (FIG. 21: Steps S2102 and S2103)

The user clustering unit 201 uses the interest degree information acquired in step S2101 and Expression 4 to cluster the users (S2102). The user clustering unit 201 stores the result in the user cluster database 202 and creates in advance a user cluster for placing the new user (S2103).

### (FIG. 21: Step S2104)

When the new user starts using the information visualization system 100, the information visualization system 100 notifies the user determination unit 203 in the center server 200 of the start. The user determination unit 203 determines to which of the user clusters the new user will belong based on the interest degree information of the new user.

### (FIG. 21: Step S2104: Supplement)

If the interest degree information of the new user can be obtained from the information visualization system 100 used by the new user, the values of the information may be used. The new user may notify the center server 200 of the interest degree information.

### (FIG. 21: Step S2105)

The user determination unit 203 transmits the interest degree information of the representative user of the user cluster including the new user to the information visualization system 100 used by the new user.

### Sixth Embodiment: Summary

In this way, the information presentation system 1000 according to the present sixth embodiment clusters a plurality of users to create user clusters. When a new user is added, the interest degree information that represents the user cluster to which the new user belongs is used as an initial value of the interest degree information of the new user. As a result, the new user without the stored interest degree information can also obtain an item map according to the interest of the user.

### Seventh Embodiment

An example of using the interest degree information of the representative user of the user cluster as the interest degree information of the new user has been described in the sixth embodiment. In place of this, a user with interest degree information most similar to the interest degree information of the new user may be searched.

For example, when the new user starts using the information presentation system 1000, an item map of one of the users stored in the user cluster database 202 is displayed on the screen as the item map of the new user. The interest degree of the new user is learned based on the history of the use of the information visualization system 100 by the new user. The user cluster with the most similar interest degree is searched, and the item map of one of the users belonging to the user cluster is displayed on the screen. According to the method, an item map suitable for the interest degree of the user can be displayed even if there are only few records of the use of the information visualization system 100 by the user.

The user cluster database 202 may be updated in the sixth embodiment. The user cluster database 202 may be updated at certain time intervals or may be updated according to the number of new users and the amount of data in the user interest degree database 101.

Although examples of combinations of item information, such as TV program information, book information, and sightseeing spot information, and various recommendation services have been described in the embodiments, it is obvious that the embodiments can be applied to functions of visualizing and displaying the items of various domains.

The present invention is not limited to the embodiments, and various modified examples are included. The embodiments are described in detail to describe the present invention in an easily understood manner, and the embodiments are not necessarily limited to the embodiments that include all configurations described above. Part of the configuration of an embodiment can be replaced by the configuration of another embodiment. The configuration of an embodiment can be added to the configuration of another embodiment. Addition, deletion, and replacement of other configurations are also possible for part of the configurations of the embodiments.

The configurations, the functions, the processing units, the processing means, etc., may be realized by hardware such as by designing part or all of the components by an integrated circuit. A processor may interpret and execute programs for realizing the functions to realize the configurations, the functions, etc., by software. Information, such as programs, tables, and files, for realizing the functions can be stored in a recording device, such as a memory, a hard disk, and an SSD (Solid State Drive), or on a recording medium, such as an IC card, an SD card, and a DVD.

### DESCRIPTION OF SYMBOLS

100: information visualization system, 101: user interest degree database, 102: item database, 103: visualization processing unit, 104: display unit, 105: operation unit, 106: item coordinate database, 107: cluster generation unit, 108: representative word extraction unit, 109: cluster structure database, 110: data update unit, 111: relevance calculation unit, 112: inter-item relevance database, 113: keyword selection unit, 114: user action history database, 115: interest degree calculation unit, 200: center server, 201: user clustering unit, 202: user cluster database, 203: user determination unit, 1000: information presentation system

What is claimed is:

1. An information visualization system comprising:
a user interest degree database that stores interest degree information describing interest degrees of users for items;
a visualization processing unit that creates an item map arranging the items on a coordinate space; and
an output unit that outputs the item map created by the visualization processing unit, wherein
the visualization processing unit
uses the interest degree information stored in the user interest degree database to calculate relevance between the items and reflects the relevance on coordinate values of the items on the item map to arrange the items on the item map.

2. The information visualization system according to claim 1, further comprising:
an item database that stores keywords indicating features of the items;
a cluster generation unit that uses coordinate values of the items on the item map to cluster the items; and
a representative word extraction unit that extracts, from the item database, the keywords indicating the features of the items belonging to clusters generated by the cluster generation unit, wherein
the output unit
outputs a result reflecting the clusters generated by the cluster generation unit and the keywords corresponding to the clusters extracted by the representative word extraction unit to the item map created by the visualization processing unit.

3. The information visualization system according to claim 2, further comprising
a cluster structure database that stores the result of the clustering, wherein
the cluster generation unit
generates the clusters to be arranged on the item map for each display scale of the item map and stores a result of the generation in the cluster structure database, and
the visualization processing unit
reads the result of the clustering corresponding to the display scale of the item map from the cluster structure database to generate the clusters.

4. The information visualization system according to claim 2, further comprising
an item coordinate database that stores the coordinate values of the items on the item map, wherein
the visualization processing unit
stores the coordinate values of the items on the item map in the item coordinate database and
when the output unit outputs the item map, reads the coordinate values of the items on the item map from the item coordinate database and transmits the coordinate values to the output unit.

5. The information visualization system according to claim 2, further comprising
a representative word edit unit that edits representative words displayed on the item map.

6. The information visualization system according to claim 2, further comprising
a data update unit that adds a new item to the item database, wherein
the data update unit
obtains an item with more than a predetermined value of the relevance to the new item among the items stored in the item database and temporarily sets the coordinate values of the item on the item map as initial coordinate values of the new item on the item map, and
the visualization processing unit
handles the initial coordinate values as initial values to rearrange the new item on the item map.

7. The information visualization system according to claim 2, further comprising
a cluster structure database that stores the result of the clustering, wherein
the cluster generation unit
determines to which of the clusters the new item will be added and placed and stores a result of the determination in the cluster structure database.

8. The information visualization system according to claim 1, further comprising:
a relevance calculation unit that calculates the relevance between the items; and
an inter-item relevance database that stores the relevance between the items calculated by the relevance calculation unit, wherein
the visualization calculation unit
reflects the relevance between the items stored in the inter-item relevance database on the coordinate values of the items on the item map to arrange the items on the item map.

9. The information visualization system according to claim 8, further comprising
an item database that stores the keywords indicating the features of the items, wherein
the relevance calculation unit
extracts the keywords not common between the items from the item database and stores the keywords in the inter-item relevance database, and
the visualization calculation unit
uses the number of keywords not common between the items stored in the inter-item relevance database as the relevance between the items.

10. The information visualization system according to claim 1, further comprising:
a user action history database that stores histories of the selection of the items by the users; and
an interest degree calculation unit that uses the histories stored in the user action history database to calculate the interest degrees of the users for the items and that stores the interest degrees in the user interest degree database.

11. The information visualization system according to claim 10, further comprising
an operation unit that receives an operation input for the item map, wherein
the user action history database stores the operation input for the operation unit as the history.

12. The information visualization system according to claim 10, wherein
the user action history database
stores, as the history, a geographic location of the information visualization system when the item is selected on the item map.

13. The information visualization system according to claim 10, wherein
the user action history database updates the history according to use frequency of the information visualization system.

14. An information presentation system comprising:
the information visualization system according to claim 1; and
a center server that clusters a plurality of users, wherein
the center server comprises:
a user clustering unit that clusters the users based on the interest degrees of the user for the items to create user clusters; and
a user determination unit that determines to which of the user clusters a new user belongs, wherein
the user determination unit
determines that the new user belongs to the user cluster with the interest degree closest to the interest degree of the new user for the item, and
the information visualization system
uses the interest degree of the user cluster to which the new user is determined to belong as an initial value of the interest degree of the new user.

15. An information presentation system comprising:
the information visualization system according to claim 1; and
a center server that determines the user with the interest degree closest to the interest degree of a new user for the item, wherein
the information visualization system
uses the interest degree of the user cluster determined to which the new user is determined to belong as an initial value of the interest degree of the new user.
